(19) United States
(12) Patent Application Publication
(10) Pub. No.: US 2007/0248270 A1
(43) Pub. Date: Oct. 25, 2007

(54) System and Method for Compression of Mixed Graphic and Video Sources

(75) Inventors: Xuejun Hu, Arlington, TX (US); Lilla L. Boroczky, Mount Kisco, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,134

(22) PCT Filed: Aug. 10, 2005
(86) PCT No.: PCT/IB05/52658

§ 371 Date: Feb. 2, 2007

Related U.S. Application Data
(60) Provisional application No. 60/601,445, filed on Aug. 13, 2004.

(51) Int. Cl. G06K 9/36

(52) U.S. Cl. 382/232

(57) ABSTRACT

A system and method for compressing a mixed graphic and video signal. A system is provided that comprises: an encoder (14) for compressing mixed graphic and video pixel blocks (56), including: a classification system (22) for classifying each inputted pixel block as one of a plurality of unique types of blocks; a plurality of encoder subsystems (32,34,36,38), wherein each of the encoder subsystems is configured to compress a unique type of block; and a rate control system (54) for attaining a target compression rate for a stream of compressed blocks; and a decoder (18) for decoding compressed pixel blocks received over an embedded communication channel from the encoder, wherein the decoder includes a plurality of decoder subsystems (62,64,66,68), each configured to uncompress a unique type of compressed block.

The present invention relates generally to systems for processing mixed graphic and video sequences, and more particularly relates to a hybrid encoding and decoding system and method for compressing mixed graphic and video data.

Current electronics products employ more and more advanced digital signal and image processing techniques, which can be very demanding for memory size and communication bandwidth between units of a system. In practice, reduction of memory size to meet implementation cost requirements or reduction of the communication bandwidth to meet the system requirements is often needed. Accordingly, signal processing techniques, such as compression, must be utilized to meet these challenges.

For instance, in complex embedded applications where data must be transferred, e.g., between driver electronics and a display panel such as that utilized in Philip's LCoS projection displays, the amount of processed data that must be transferred is huge because of features like R, G, B color space, high display resolution, required 180 Hz display frame rate, etc. These, as well as other features, have resulted in memory bandwidth and transmission bandwidth “bottlenecks.”

Such challenges are made more acute by systems that process mixed signal, e.g., video and graphics. The processing of a mixed signal can be a complex problem, because the source has varying signal statistics. Graphic data and video data need to be distinguished to apply different video processing due to their different characteristics. For example, standard video compression techniques often introduce “blurring” and “rippling” artefacts in sharp-edge occasions. These artefacts appear frequently and are much more annoying in graphics. Accordingly, it is preferable that certain types of compression be applied to one type of signal, e.g., video, and not to others, e.g., graphics. Moreover, in complex embedded applications where data must be transferred, e.g., between driver electronics and a display panel such as that utilized in Philip's LCoS projection displays, the amount of processed data that must be transferred is huge because of features like R, G, B color space, high display resolution, required 180 Hz display frame rate, etc. These, as well as other features, have resulted in memory bandwidth and transmission bandwidth “bottlenecks.”

Various compression solutions have been proposed, including, Lam et al., Memory Reduction for HDTV Decoders, IBM J. Res. Develop., Vol. 43, No. 4, which proposed a lossy Hadamard transform-based compression system for reducing memory size on HD MPEG-2 decoders. This compression system has low computational complexity compared to other transform-based compression system. However, it is applicable only for pure video sources and its performance not sufficient in certain areas (e.g. flat area) of a video frame. Similarly, Lee et al., A low Complexity Frame Memory Compression Algorithm and its Implementation for MPEG-2 Video Decoder, proposes a hybrid compression system, but it is suitable only for pure video compression.

Accordingly, a need exists for a system and method of effectively compressing mixed video and graphic signals.

The present invention addresses the above-mentioned problems, as well as others, by providing a hybrid encoding and decoding system and method for compressing mixed graphic and video data. The system adaptively combines lossy and lossless compression techniques to achieve visually-lossless compression for a vast variety of sources, such as pure video signals, pure graphics signals and mixed video and graphics. It adaptively changes the compression methods from block to block based on classification information. The computational complexity is very low allowing real-time implementation while achieving high picture quality.

Utilizing the invention, a 2:1 compression ratio can be achieved without visually noticeable artifacts and the necessary computations can be achieved with only one line of memory. The invention can process pure graphic, pure video and mixed video and graphic sources without prior knowledge of the source type. This system can also be extended to reduce the memory size in a display system, thereby enabling further cost reduction.

In a first aspect, the invention provides an encoder for compressing a mixed graphic and video signal, comprising: a classification system for classifying inputted blocks of pixel data as one of a plurality of unique types of blocks; a plurality of encoder subsystems, wherein each of the encoder subsystems is configured to compress a unique type of block; and a rate control system for attaining a target compression rate for a stream of compressed blocks.

In a second aspect, the invention provides a video processing system for processing mixed graphic and video signals, comprising: an encoder for compressing a mixed graphic and video pixel blocks, including: a classification system for classifying each inputted pixel block as one of a plurality of unique types of blocks; a plurality of encoder subsystems, wherein each of the encoder subsystems is configured to compress a unique type of block; and a rate control system for attaining a target compression rate for a stream of compressed blocks; and a decoder for decoding compressed pixel blocks received over an embedded communication channel from the encoder, wherein the decoder includes a plurality of decoder subsystems, each configured to uncompress a unique type of compressed block.

In a third aspect, the invention provides a method for compressing a mixed graphic and video signal, comprising: classifying inputted pixel blocks as unique block type selected from a plurality of predetermined block types; encoding inputted blocks with a selected one of a plurality of encoder subsystems, wherein the selected encoder subsystem depends upon the block type, and wherein each of the encoder subsystems is configured to compress a unique block type; and employing a rate control strategy for attaining a target compression rate for a stream of compressed blocks.

These and other features of this invention will be more readily understood from the following detailed description of the various aspects of the invention taken in conjunction with the accompanying drawings in which:

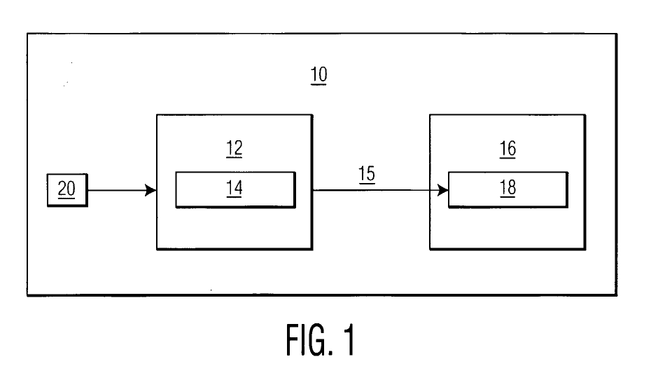

FIG. 1 depicts a video processing system in accordance with an embodiment of the present invention.

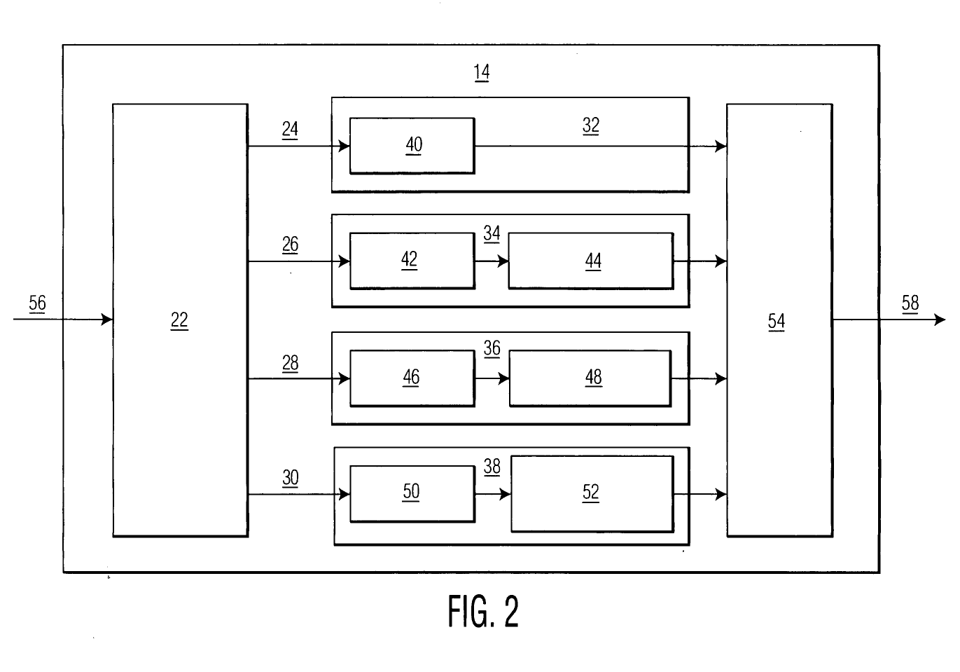

FIG. 2 depicts an encoder in accordance with an embodiment of the present invention.

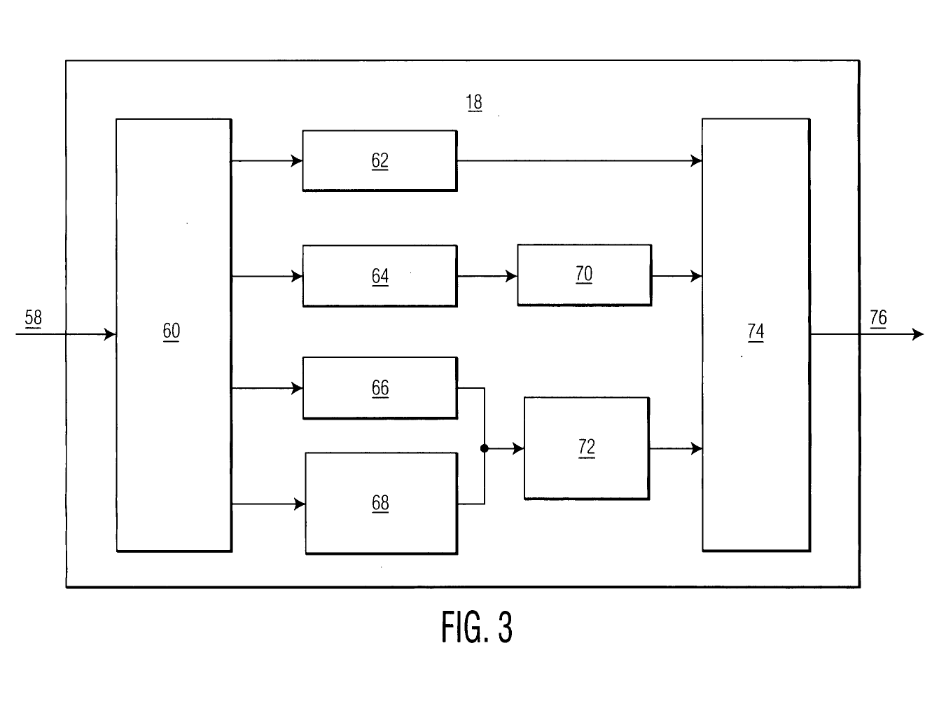

FIG. 3 depicts a decoder in accordance with an embodiment of the present invention.

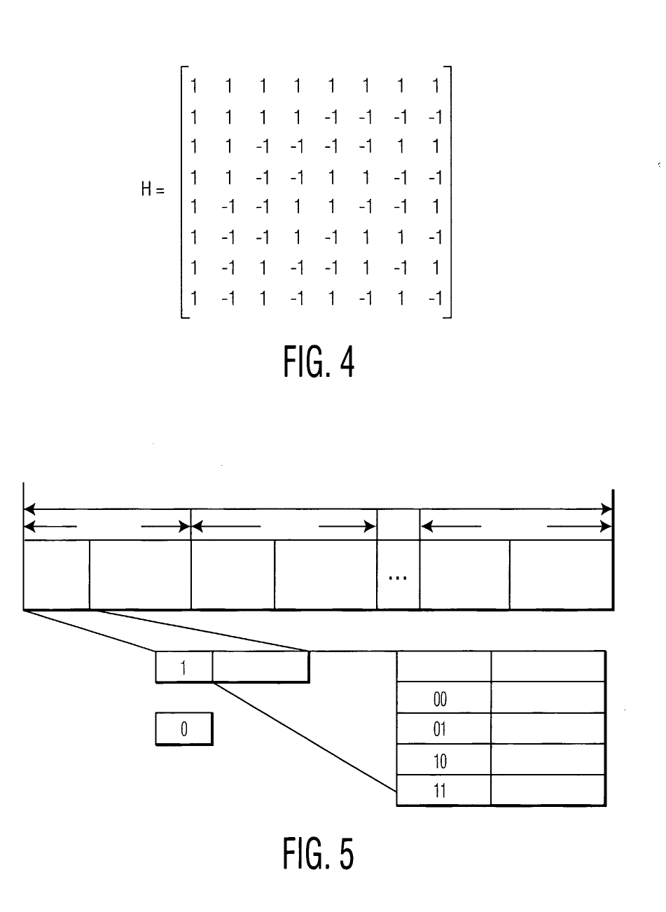

FIG. 4 depicts a Hadamard matrix.

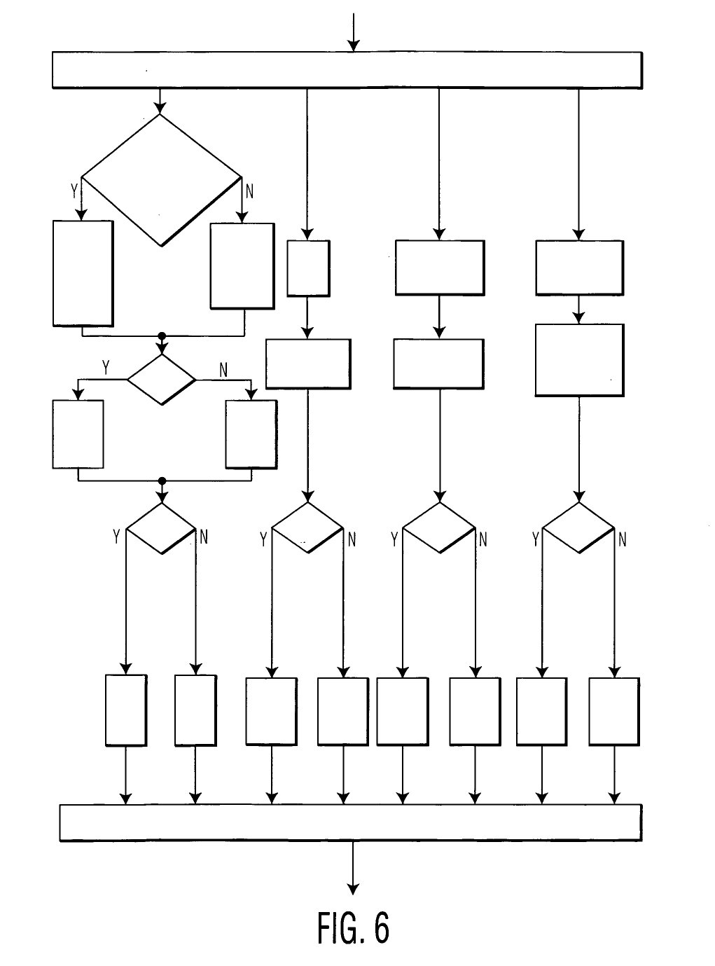

FIG. 5 depicts a packet configuration of the compressed bitstream having header information in accordance with the present invention.

FIG. 6 depicts a flow diagram of an embodiment for generating header information in accordance with the present invention.

Referring now to FIG. 1, an illustrative video processing system 10 is shown that includes an embedded transmission channel 15 for transmitting data between display driver electronics 12 (“driver”) and a display 16, which requires a high data rate. Inside driver 12 and display 16 are an encoder 14 and a decoder 18, respectively, for compressing and decompressing transmitted data. It should be noted that while the present invention is described in the context of compressing data in an embedded video application, the invention can be applied to any system that processes mixed graphic and video signals.

As described in further detail below, the encoder 14 employs an adaptive, hybrid coding scheme, and the decoder 16 implements the inverse process. In one illustrative embodiment, the encoder 14 operates on one-dimensional (1D) 1×8 block segments, which are obtained from each row of an input signal. Encoder 14 detects and differentiates the blocks as pure graphic, sharp transition, flat area and normal video blocks. Based on the classification, the encoder 14 will utilize one of four different encoding paths depending on block type.

FIG. 2 depicts encoder 14 in more detail. A mixed signal input block 56, e.g., comprising a 1×8 block of RGB pixel data, is initially processed by a classification system 22, which classifies the block as a pure graphic block 24, a flat area block 26, a sharp transition block 28, or a normal video block 30. Any technique for classifying blocks may be utilized. For example, see co-pending patent application entitled, ADAPTIVE CLASSIFICATION SYSTEM AND METHOD FOR MIXED GRAPHIC AND VIDEO SEQUENCES, filed on Aug. 13, 2004, Ser. No. 60/601,446, which is hereby incorporated by reference.

Encoder 14 comprises four encoder subsytems 32, 34, 36, and 38. Depending on which classification is selected by classification system 22, one of the encoder subsystems is utilized to encode the block 56. Accordingly, if a block is classified as a pure graphic block, then subsytem 32 is utilized; if the block is classified as a flat area block 26; then subsytem 34 is utilized; if the block is classified as a sharp transition block; then subsystem 36 is utilized; and if the block is classified as a normal video block, then subsystem 38 is utilized.

In order to achieve a particular compression (e.g., a 2:1 reduction) using the various encoder subsystems, a rate control system 54 is utilized to generate an output stream 58 at a predetermined bit rate. The details of the rate control system 54 are provided below.

The first encoder subsystem 32 includes a pure graphic encoder 40 for encoding pure graphic blocks. Pure graphic encoder 40 may be implemented as follows. If the block is bi-value, i.e., all pixel values are either a background value or a text value, pure graphic encoder 40 will transmit a 24 bit value to represent the block. The encoded value will include a background value (i.e., a minimum value) in eight bits, an eight bit text value (i.e., a maximum value), and an eight bit symbol. The eight bit symbol tells whether a text value or a background value holds each of the individual pixel positions within a block, e.g., “1” indicates text and “0” indicates background. If all pixels in a block have identical values, the pixel value can be transmitted using only eight bits.

For example, to encode a bi-value pure graphic block with pixel values of [10 10 10 255 255 255 10 10], the background=10=00001010B (wherein B means a binary value), and the text value=255=11111111B. The symbol value=00011100, so that the 24 bit encoded block=000010101111111100011100.

The second encoder subsystem 34 comprises a linear predictor 42 and a Golumb-Rice coding system 44. In this case, the 1×8 block of pixels are fed into linear predictor to generate a prediction error. Then, the prediction error goes through a Golomb-Rice coding system 44. The prediction of each pixel, except the first one, comes directly from the previous pixel value. For the first pixel in a block, its own value is used as a prediction error if the previous block is not a “flat area” block; otherwise the last pixel value in previous block is used as its predicted value.

Golomb-Rice coding system 44 utilizes a variable-length encoding scheme, wherein if most of the numbers are small, good compression can be achieved. Golomb-Rice coding works with a parameter m, where m=2^{k}, and k is the number of bits in the LSB (least significant bits). The procedure of encoding a number x is shown as below:
1. Let MSB (most significant bits) q=x/m (fractions are rounded down, if any), output q binary zeros.
2. Output a binary one to indicate the ending of MSB coding.
3. Append k bits of LSB.
4. Add 1 bit for sign (0 for positive value, 1 for negative value).

For example, to encode x=16=10000B, with k=4, MSB: x/m=16/(2ˆ4)=1 (note, if e.g., x=15 and m=2; MSB=floor(15/2)=7), and LSB=“0000.” Golomb-Rice coding is as follows: MSB coding (“0”)+Indicator (“1”)+LSB (“0000”)+sign (‘0”)=0100000.

In general, a lower value of k will make smaller numbers shorter and bigger numbers longer, an a bigger value of k will make big numbers relatively shorter, while increasing the overhead on all smaller values and making them longer. In encoder 14, the prediction error in a flat area block 26 is small, so k may, e.g., be set equal to one to achieve satisfactory compression.

The third encoder subsystem 36 operates on sharp transition blocks 28 utilizing a Hadamard transform 46 and a fixed uniform quantizer 48. The Hadamard transform 46 has high-energy compaction; and the elements of the basis vectors take only the binary values +1 and −1. They are, therefore, well suited for an embedded compression algorithm where computational simplicity is required. The 8×8 Hadamard transform matrix is defined as shown in FIG. 4. The transform is implemented by performing a matrix multiplication of the inputted 1×8 block with the Hadamard matrix, resulting in a 1×8 block of Hadamard coefficients.

In the illustrative embodiment, an 8×8 Hadamard matrix is employed to transform 1×8 pixel blocks into eight Hadamard coefficients. The uniform quantizer 48 may comprise a traditional design based on a bit allocation theory to arrive at the target compression ratio and satisfying picture quality. However, in “sharp transition” blocks, the sharp transition edges cause energy spreading in the spectral block, and the traditional quantizer design may therefore not achieve good picture quality. Accordingly, coding efficiency can be sacrificed to reduce such picture quality degradation. In the proposed algorithm, a 49-bit uniform quantizer with a step size of 32 may be used after the Hadamard transform 46 to keep the sharp transition sharp and neat.

The fourth encoder subsystem 38 encodes normal video blocks 30 using a Hadamard transform 50 and an adaptive non-uniform quantizer 52. The 8 pixels of the input block are Hadamard transformed and the resulting frequency coefficients are quantized. According to the statistics of the Hadamard transform coefficients, a uniform quantizer has been designed for DC components. For AC components, non-uniform 35-bit, 31-bit and 30-bit scalar quantizers may be utilized, which are employed adaptively under a bit rate control strategy to achieve a target compression (e.g., 2:1) for each row in a frame.

Scalar quantization has low computation costs and is easy to implement. It can achieve good compression performance if applied properly. In one illustrative embodiment, the scalar quantization can be designed to compress Hadamard transform coefficients using three steps: (1) Statistical analyses of Hadamard transform coefficients; (2) Bit allocation; and (3) Quantization table design.

Statistical analyses of Hadamard transform 50 may be accomplished by, e.g., examining several high definition (HD) sequences to obtain some statistical properties of the coefficients. Statistical data (e.g., using a probability density function of the Hadamard coefficients) shows that the transformed AC coefficients are nearly identically distributed after normalization and resemble a Laplacian density function as defined by:
p(x)=1/σ²e^{-2|x|lσ**2}, where σ² denotes the variance.

The distribution of the DC coefficient is not symmetric and its shape depends on the brightness of the pictures in the sequence. Based on these characteristics, a uniform quantizer may be utilized to compress the DC coefficient and a set of non-uniform scalar quantizers to encode the AC coefficients.

Bit allocation may be determined as follows. Rate distortion theory and bit rate control suggest allocating more bits to the coefficients with larger variance. The optimum bit allocation is given by:

$${b}_{i} = \frac{B}{K} + \frac{1}{2} {log}_{2} \frac{{σ}_{i}^{2}}{[ {\prod }_{i = 1}^{k} {σ}_{i}^{2} ]}$$

where B is the total number of available bits and K is the number of coefficients, and σᵢ²=var[Cᵢ] is the variance of the coefficients. After calculation using the above equation combined with empirically calculated variances, the same optimum bit allocations for the RGB components in the 32-bit quantizer design can be obtained. Similar bit allocation results for 35-bit, 31-bit and 30-bit quantizers can likewise be obtained.

Quantization table design may be achieved as follows. For DC components, a uniform quantizer is utilized. The DC coefficients after a Hadamard transform vary from 0 to 2040, so a uniform quantizer can be designed as:
tₖ=2040(k−1)/2^{m}, k=1, . . . ,2^{m} (1)
rₖ=tₖ+2040/2^{m}, k=1, . . . ,2^{m} (2)
where m is the number of bits of the quantizer, tₖ is the decision level, and rₖ is the reconstruction level.

For AC components, a non-uniform quantizer 52 may be utilized. To keep the number of quantizers as small as possible, seven AC coefficients may be combined into four groups with corresponding four quantizers as follows: Q1 (5 bits, 31 levels), Q2 (4 bits, 15 levels), Q3 (3 bits, 7 levels), and Q4 (3 bits, 3 levels). A Lloyd-Max quantizer design may be employed, which finds the desirable decision levels tₖ and reconstruction levels rₖ in order to minimize the mean square error.

Turning now to FIG. 5, an illustrative bit stream structure created by encoder 14 is shown. The bit stream is transmitted block by block and line by line. Each encoded block contains a header and a payload. The header lets the decoder 18 know how to decode the payload. Two different kinds of headers are used. A “transition block” header contains 3 bits, while a “consecutive or continuous block” header contains only 1 bit. A transition block means that the current block is a different type from the previous block. A “1” is sent indicating a transition block, followed by an additional 2 bits carrying information of the block type. A consecutive block means that the current block is the same type as the previous one.

FIG. 6 shows a flow chart of an example of the creation of a bit structure in more detail. For pure graphic blocks, a “1 00” is transmitted if the previous block was a pure graphic block and a “0” is transmitted if it was not. If all pixels have an identical value, an extra “1” is transmitted indicating that the block will be compressed to 8 bits. Otherwise, an extra “0” is transmitted indicating that the block will be compressed to 24 bits, as described above. If the block is a flat area block, then a “1 01” is transmitted if the previous block was a flat area block or a zero if it was not. If the block is a sharp transition block, then a “1 01” is transmitted if the previous block was a sharp transition block or a zero if it was not. Finally, if the block is a normal video block, then a “1 11” is transmitted if the previous block was a normal video block or a zero if it was not. Obviously, different strategies could be utilized without departing from the scope of the invention.

As noted a bit rate control system 54 (FIG. 1) is provided to achieve a target compression. In the illustrative embodiment, a target compression of 2:1 is described. However, it should be understood that variations to the target compression may be implemented without departing from the scope of the invention. Bit rate control may be implemented as follows. The four different compression techniques produce different compression data length. In addition, Golomb-Rice coding is itself a various-length coding, so a bit rate control strategy is utilized to achieve a fixed bit length for each row. If many consecutive blocks are classified as flat area blocks or pure graphic blocks in the first half portion of a row, the compression ratio will generally be higher than 2:1 up to the end of the first half of the row, thus more bits can be used for quantization of Hadamard coefficients in the remaining portion of the row.

Overall, the different compression methods can benefit from each other based on the bit rate control strategy to achieve the best overall picture quality for a frame. The details of the rate control can be summarized as: (1) A non-compressed 1×8 block contains 64 bits. Assuming 2:1 compression, the compressed 1×8 block has bit budget of 32 bits; (2) B is the target bit budget for encoding N blocks, B=32*N; (3) C is the sum of the bits consumed by N-1 blocks before coding block N; (4) R is the bit budget left for encoding block N, R=B-C, if R>th1 (e.g., th1=45) then apply 35-bit quantization, else if R>th2 (e.g. th2=31) apply 31-bit quantization, else apply 30-bit quantization. Obviously different strategies may be utilized without departing from the scope of the invention.

FIG. 3 depicts a decoder 18 in more detail. Decoder 18 receives a stream of encoded data 58 into a header decoding system 60. By examining the headers (described above) header decoding system 60 will cause one of four possible decoding strategies to be envoked. Namely, decoder 18 includes a pure graphic decoder 62 for decoding pure graphic data; a Golumb-Rice decoder 64/DPCM decoder 70 for decoding flat area data; an inverse uniform quantizer 66/Inverse Hadamard transform 72 for decoding sharp transition data; and an inverse non-uniform quantizer 68/Inverse Hadamard transform 72 for decoding normal video data. After decoding, a multiplexer 74 is utilized to reassemble the decoded data from each of the different decoder paths to generate output 76.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which - when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. An encoder (14) for compressing a mixed graphic and video signal (56), comprising:
a classification system (22) for classifying inputted blocks of pixel data as one of a plurality of unique types of blocks;
a plurality of encoder subsystems (32,34,36,38), wherein each of the encoder subsystems is configured to compress a unique type of block; and
a rate control system (54) for attaining a target compression rate for a stream of compressed blocks.

2. The encoder of claim 1, wherein the plurality of unique types of blocks comprises a pure graphic block (24), a flat area block (26), a sharp transition block (28), and a normal video block (30).

3. The encoder of claim 2, wherein the plurality of encoder subsystems include:
a first subsystem comprising a pure graphic encoder (40);
a second subsystem comprising a predictor (42) and a Golumb-Rice coding system (44);
a third subsystem comprising a Hadamard transform (46) and a fixed uniform quantizer (48); and
a fourth subsystem comprising a Hadamard transform (46) and an adaptive non-uniform quantizer (52).

4. The encoder of claim 1, wherein the target compression rate is 2:1.

5. The encoder of claim 1, wherein each inputted block of pixel data consists of a 1×8 block of pixel data.

6. The encoder of claim 1, wherein each compressed block includes a header that dictates what encoder subsystem was used to compress the block.

7. The encoder of claim 6, wherein the header dictates whether the compressed block is a transition block or a consecutive block.

8. The encoder of claim 1, wherein the block of pixel data comprises RGB data.

9. The encoder of claim 1, wherein the rate control system attains a target compression rate for a row of blocks.

10. A video processing system (10) for processing mixed graphic and video signals, comprising:
an encoder (14) for compressing a mixed graphic and video pixel blocks, including:
a classification system for classifying each inputted pixel block as one of a plurality of unique types of blocks;
a plurality of encoder subsystems, wherein each of the encoder subsystems is configured to compress a unique type of block; and
a rate control system for attaining a target compression rate for a stream of compressed blocks; and
a decoder (18) for decoding compressed pixel blocks received over an embedded communication channel from the encoder, wherein the decoder includes a plurality of decoder subsystems (62,64,66,68), each configured to uncompress a unique type of compressed block.

11. The video processing system of claim 10, wherein the plurality of unique types of blocks comprises a pure graphic block, a flat area block, a sharp transition block, and a normal video block.

12. The video processing system of claim 11, wherein the plurality of encoder subsystems include:
a first subsystem comprising a pure graphic encoder;
a second subsystem comprising a predictor and a Golumb-Rice coding system;
a third subsystem comprising a Hadamard transform and a fixed uniform quantizer; and
a fourth subsystem comprising a Hadamard transform and an adaptive non-uniform quantizer.

13. The video processing system of claim 10, wherein the target compression rate is 2:1.

14. The video processing system of claim 10, wherein each inputted pixel block consists of a 1×8 block of pixel data.

15. The video processing system of claim 10, wherein each compressed block includes a header that dictates what encoder subsystem was used to compress the block.

16. The video processing system of claim 15, wherein the header dictates whether the compressed block is a transition block or a consecutive block.

17. The video processing system of claim 10, wherein the pixel block comprises RGB data.

18. The video processing system of claim 10, wherein the rate control system attains the target compression rate for a row of inputted blocks.

19. The video processing system of claim 10, wherein the encoder is contained in a display driver and the decoder is contained in a display.

20. A method for compressing a mixed graphic and video signal, comprising:
classifying inputted pixel blocks as unique block type selected from a plurality of predetermined block types;
encoding inputted blocks with a selected one of a plurality of encoder subsystems, wherein the selected encoder subsystem depends upon the block type, and wherein each of the encoder subsystems is configured to compress a unique block type; and
employing a rate control strategy for attaining a target compression rate for a stream of compressed blocks.

21. The method of claim 20, wherein the plurality of unique block types comprise a pure graphic block, a flat area block, a sharp transition block, and a normal video block.

22. The method of claim 21, wherein the plurality of encoder subsystems include:
a first subsystem comprising a pure graphic encoder;
a second subsystem comprising a predictor and a Golumb-Rice coding system;
a third subsystem comprising a Hadamard transform and a fixed uniform quantizer; and
a fourth subsystem comprising a Hadamard transform and an adaptive non-uniform quantizer.

23. The method of claim 20, wherein the target compression rate is 2:1.

24. The method of claim 20, wherein each inputted pixel block consists of a 1×8 block of pixel data.

25. The method of claim 20, wherein each compressed block includes a header that dictates what encoder subsystem was used to compress the block.

26. The method of claim 25, wherein the header dictates whether the compressed block is a transition block or a consecutive block.

27. The method of claim 20, wherein each inputted pixel block comprises RGB data.

28. The method of claim 20, wherein the rate control strategy attains the target compression rate for each row of blocks.
